(19) United States
(12) Patent Application Publication
(10) Pub. No.: US 2014/0021923 A1
(43) Pub. Date: Jan. 23, 2014

(54) ELECTRICAL STORAGE SYSTEM, AND CONTROL METHOD FOR ELECTRICAL STORAGE SYSTEM

(71) Applicant: Masatoshi UCHIDA, Toyota-shi (JP)

(72) Inventor: Masatoshi UCHIDA, Toyota-shi (JP)

(73) Assignee: TOYOTA JIDOSHA KABUSHIKI KAISHA, Toyota-shi (JP)

(21) Appl. No.: 13/943,135

(22) Filed: Jul. 16, 2013

(30) Foreign Application Priority Data
Jul. 20, 2012 (JP) 2012-162002

(51) Int. Cl. H02J 7/00

(52) U.S. Cl. CPC H02J 7/007
USPC 320/118

(57) ABSTRACT

An electrical storage system including electrical storage devices, relays and a controller, and a control method therefor are provided. When the electrical storage devices are discharged, the controller isolates the completely discharged electrical storage element from a current path with a corresponding bypass circuit, and isolates the completely discharged electrical storage device from the current path with the corresponding relay. When the electrical storage devices are charged, the completely charged electrical storage element is isolated from the current path with the corresponding bypass circuit, and the completely charged electrical storage device is isolated from the current path with the corresponding relay. When the electrical storage devices are charged after being discharged, the full charge capacities of each electrical storage element and each electrical storage device are calculated by accumulating a current value until being isolated from the current path.

### BACKGROUND OF THE INVENTION

1. Field of the Invention

The invention relates to an electrical storage system that includes a plurality of electrical storage devices in each of which a plurality of electrical storage elements are serially connected and that is able to efficiently charge or discharge each of the electrical storage elements and each of the electrical storage devices, and a control method for the electrical storage system.

2. Description of Related Art

There is a battery pack formed by serially connecting a plurality of single cells. Here, when the battery pack is continuously used, there may occur variations in SOC among the plurality of single cells due to, for example, variations in degradation among the plurality of single cells. In addition, when the battery pack is formed by using a plurality of used single cells, variations in state of charge (SOC) easily occur among the plurality of single cells.

When there are variations in state of charge (SOC) among the plurality of single cells that constitute the battery pack, a discharge of the battery pack is limited with reference to the single cell that has the lowest SOC or a charge of the battery pack is limited with reference to the single cell that has the highest SOC. When a discharge of the battery pack is limited as described above, the single cells that have not been completely discharged may be left in the battery pack. In addition, when a charge of the battery pack is limited as described above, the single cells that have not been completely charged may be left in the battery pack.

### SUMMARY OF THE INVENTION

The invention provides an electrical storage system that sufficiently charges or discharges each electrical storage device and each electrical storage element and that accurately acquires a full charge capacity of each electrical storage device and a full charge capacity of each electrical storage element, and a control method for the electrical storage system.

An aspect of the invention provides an electrical storage system that includes: a plurality of parallel connected electrical storage devices; a plurality of relays each provided in correspondence with a corresponding one of the plurality of electrical storage devices; and a controller that controls a charge or discharge of the plurality of electrical storage devices. Each of the electrical storage devices includes a plurality of serially connected electrical storage elements and bypass circuits each connected in parallel with a corresponding one of the electrical storage elements. Each of the relays switches between a state where a corresponding one of the electrical storage devices is connected to a current path for charging or discharging and a state where a corresponding one of the electrical storage devices is isolated from the current path.

The controller is configured to, when the plurality of electrical storage devices are discharged, isolate the completely discharged electrical storage element from the current path with the use of a corresponding one of the bypass circuits, and isolate the completely discharged electrical storage device from the current path with the use of a corresponding one of the relays. The controller is configured to, when the plurality of electrical storage devices are charged, isolate the completely charged electrical storage element from a current path with the use of a corresponding one of the bypass circuits, and isolate the completely charged electrical storage device from the current path with the use of a corresponding one of relays. When the plurality of electrical storage devices are charged after being discharged, the controller calculates a full charge capacity of each of the electrical storage element and a full charge capacity of each of the electrical storage devices by accumulating a current value flowing through each of the electrical storage elements and each of the electrical storage devices until the corresponding electrical storage element or the corresponding electrical storage device is isolated from the current path.

With the thus configured electrical storage system, it is possible to sufficiently discharge or sufficiently charge each of the electrical storage elements included in each of the electrical storage devices with the use of the bypass circuits. Here, even when electric energy stored in a specified one of the electrical storage elements is sufficiently output through a discharge of the corresponding electrical storage device, electric energy may be still stored in the other electrical storage elements. In this case, it is possible to discharge only the other electrical storage elements by not discharging the specified one of the electrical storage elements with the use of a corresponding one of the bypass circuits. Thus, it is possible to sufficiently discharge all the electrical storage elements included in the corresponding electrical storage device.

In addition, even when a specified one of the electrical storage elements is set to a full charge state through a charge of the corresponding electrical storage device, the other electrical storage elements may not be in a full charge state. In this case, it is possible to charge only the other electrical storage elements by not charging the specified one of the electrical storage elements with the use of a corresponding one of the bypass circuits. Thus, it is possible to set all the electrical storage elements included in the corresponding electrical storage device to a full charge state.

In addition, it is possible to sufficiently discharge or sufficiently charge each of the plurality of electrical storage devices by driving the relays. Even when electric energy stored in a specified one of the electrical storage devices is sufficiently discharged through a discharge of the plurality of electrical storage devices, electric energy may be still stored in the other electrical storage devices. In this case, it is possible to discharge only the other electrical storage devices by not discharging the specified one of the electrical storage devices with the use of a corresponding one of the relays. Thus, it is possible to sufficiently discharge all the electrical storage devices.

In addition, even when a specified one of the electrical storage devices is set to a full charge state through a charge of the plurality of electrical storage devices, the other electrical storage devices may not be set to a full charge state. In this case, it is possible to charge only the other electrical storage devices by not charging the specified one of the electrical storage devices with the use of a corresponding one of the relays. Thus, it is possible to set all the electrical storage devices to a full charge state.

As described above, by sufficiently discharging or sufficiently charging each of the electrical storage elements included in each of the electrical storage devices, it is possible to accurately calculate the full charge capacity of each of the electrical storage elements: That is, by charging each of the electrical storage elements to a full charge state after each of the electrical storage elements has been completely discharged, it is possible to measure the full charge capacity of each of the electrical storage elements.

Similarly, by sufficiently discharging or sufficiently charging each of the electrical storage devices, it is possible to accurately calculate the full charge capacity of each of the electrical storage devices. That is, by charging each of the electrical storage devices to a full charge state after each of the electrical storage devices has been completely discharged, it is possible to measure the full charge capacity of each of the electrical storage devices.

Here, when it is determined that an SOC of any one of the electrical storage elements has reached 0%, the any one of the electrical storage elements, of which the SOC has reached 0%, may be isolated from the current path with the use of a corresponding one of the bypass circuits. Here, first switches may be respectively connected in series with the electrical storage elements, second switches may be respectively arranged in the bypass circuits, and the controller may be configured to isolate the electrical storage element from the current path by turning off a corresponding one of the first switches and turning on a corresponding one of the second switches. Thus, it is possible to discharge only the other electrical storage elements by not discharging the electrical storage element of which the SOC has reached 0%. It is possible to discharge all the electrical storage elements included in each of the electrical storage devices until the SOC reaches 0%.

By focusing on a voltage variation amount of the electrical storage element per predetermined period of time or a discharge termination voltage of the electrical storage element, it may be determined whether the SOC of the electrical storage element has reached 0%. When the SOC of the electrical storage element has reached 0%, a voltage variation amount corresponding to this situation may be exhibited, so it is possible to determine that the SOC of the electrical storage element has reached 0% by recognizing the voltage variation amount. In addition, when the SOC of the electrical storage element has reached 0%, the voltage of the electrical storage element has reached the discharge termination voltage. Therefore, by recognizing the fact that the voltage value of the electrical storage element has reached the discharge termination voltage, it is possible to determine that the SOC of the electrical storage element has reached 0%.

Each of the electrical storage elements included in each of the electrical storage devices is isolated from the current path on the basis of the fact that the SOC reaches 0%. Therefore, when all the electrical storage elements that constitute any one of the electrical storage devices are isolated from the current path, it is possible to determine that the corresponding electrical storage device has been completely discharged. That is, it is possible to determine that the SOC of the corresponding electrical storage device has reached 0%.

Here, when it is determined that an SOC of any one of the electrical storage elements has reached 100%, the any one of the electrical storage elements, of which the SOC has reached 100%, may be isolated from the current path with the use of a corresponding one of the bypass circuits. Thus, it is possible to charge all the electrical storage elements included in each of the electrical storage devices until the SOC reaches 100%.

By focusing on a voltage variation amount of the electrical storage element per predetermined period of time, a resistance variation amount of the electrical storage element per predetermined period of time or a temperature variation amount of the electrical storage element per predetermined period of time, it may be determined whether the SOC of the electrical storage element has reached 100%. When the SOC of the electrical storage element has reached 100%, a voltage variation amount (a resistance variation amount or a temperature variation amount) corresponding to this situation may be exhibited. Therefore, by recognizing the voltage variation amount (the resistance variation amount or the temperature variation amount), it is possible to determine that the SOC of the electrical storage element has reached 100%.

Each of the electrical storage elements included in each of the electrical storage devices is isolated from the current path on the basis of the fact that the SOC reaches 100%. Therefore, when all the electrical storage elements that constitute any one of the electrical storage devices are isolated from the current path, it is possible to determine that the corresponding electrical storage device has been completely charged. That is, it is possible to determine that the SOC of the corresponding electrical storage device has reached 100%.

Another aspect of the invention provides a control method of controlling a charge or discharge of a plurality of parallel connected electrical storage devices. As described above, each of the electrical storage devices includes a plurality of electrical storage elements and a plurality of bypass circuits. Here, in the control method, when the plurality of electrical storage devices are discharged, the completely discharged electrical storage element is isolated from the current path with the use of a corresponding one of the bypass circuits, and the completely discharged electrical storage device is isolated from the current path with the use of a corresponding one of the relays each provided in correspondence with a corresponding one of the electrical storage devices.

When the plurality of electrical storage devices are charged, the completely charged electrical storage element is isolated from the current path with the use of a corresponding one of the bypass circuits, and the completely charged electrical storage device is isolated from the current path with the use of a corresponding one of the relays. When the plurality of electrical storage devices are charged after being discharged, a full charge capacity of each of the electrical storage elements and a full charge capacity of each of the electrical storage devices are calculated by accumulating a current value flowing through each of the electrical storage elements and each of the electrical storage devices until the corresponding electrical storage element or the corresponding electrical storage device is isolated from the current path. With the thus configured control method, similar advantageous effects to those of the above-described invention may be obtained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view that shows the configuration of a battery system according to an embodiment of the invention;

FIG. 2 is a view that mainly shows the configuration of each monitoring unit in the battery system;

FIG. 3 is a view that shows a circuit for bypassing each single cell in the battery system;

FIG. 4 is a view that shows a circuit configuration at the time when current flows through all the single cells in FIG. 3;

FIG. 5 is a view that shows a circuit configuration at the time when a selected one of the single cells is bypassed in FIG. 3;

FIG. 6 is a flowchart that shows the process of discharging all the single cells and all the battery packs in the battery system;

FIG. 7 is a flowchart that shows the process of determining whether the SOC of the single cell has reached 0% in the battery system;

FIG. 8 is a graph that shows a variation in the voltage of the single cell during discharging in the battery system;

FIG. 9 is a flowchart that shows the process of determining whether the SOC of the battery pack has reached 0% in the battery system;

FIG. 10 is a flowchart that shows the process of determining whether the SOC of all the battery packs has reached 0% in the battery system;

FIG. 11 is a flowchart that shows the process of charging all the single cells and all the battery packs in the battery system;

FIG. 12 is a flowchart that shows the process of determining whether the SOC of the single cell has reached 100% in the battery system;

FIG. 13 is a graph that shows a variation in the voltage of the single cell during charging in the battery system;

FIG. 14 is a flowchart that shows the process of determining whether the SOC of the single cell has reached 100% in the battery system;

FIG. 15 is a graph that shows a variation in the resistance of the single cell during charging in the battery system;

FIG. 16 is a flowchart that shows the process of determining whether the SOC of the single cell has reached 100% in the battery system;

FIG. 17 is a graph that shows a variation in the temperature of the single cell during charging in the battery system; and

FIG. 18 is a flowchart that shows the process of determining whether the SOC of the battery pack has reached 100% in the battery system.

### DETAILED DESCRIPTION OF EMBODIMENTS

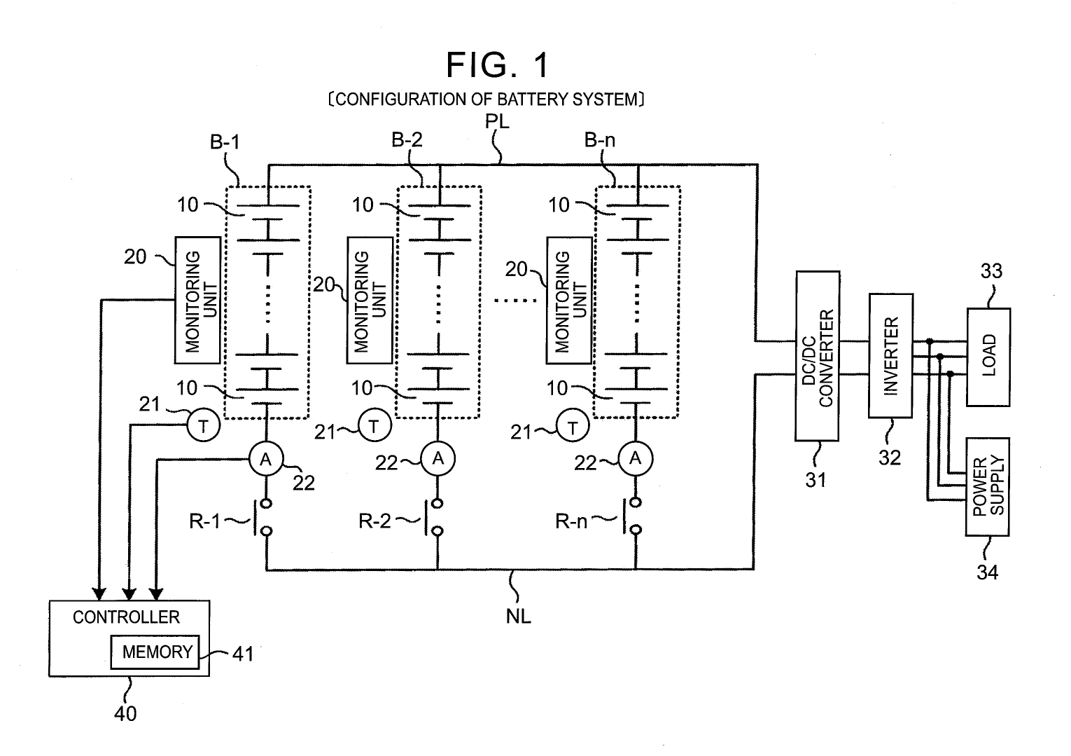

Hereinafter, an embodiment of the invention will be described. A battery system (which corresponds to an electrical storage system) according to the embodiment of the invention will be described with reference to FIG. 1. FIG. 1 is a schematic view that shows the configuration of the battery system according to the present embodiment.

The battery system shown in FIG. 1 is a so-called stationary battery system, and is installed at a specified site in a house, a commercial facility, or the like. The battery system includes a plurality of parallel connected battery packs (which correspond to electrical storage devices) B-1 to B-n. The number n of the battery packs may be set as needed.

By connecting the plurality of battery packs B-1 to B-n in parallel with one another, it is possible to ensure the full charge capacity of the battery system. That is, the full charge capacity in the case where the plurality of battery packs B-1 to B-n are connected in parallel with one another is larger than the full charge capacity in the case where the plurality of battery packs B-1 to B-n are connected in series with one another.

The battery pack B-1 includes a plurality of serially connected single cells (which correspond to electrical storage elements) 10. Here, the number of the single cells 10 that constitute the battery pack B-1 may be set as needed. Each single cell 10 may be a secondary battery, such as a nickel metal hydride battery and a lithium ion battery. Instead of the secondary battery, an electric double layer capacitor may be used.

The battery pack B-1 may be a newly manufactured battery pack B-1 or may be a used battery pack B-1. The used battery pack B-1 may be, for example, the battery pack B-1 that has been used in a vehicle.

When the battery pack B-1 is mounted on a vehicle, and any one of the single cells 10 included in the battery pack B-1 has degraded, the battery pack B-1 may be removed from the vehicle. The battery pack B-1 may be used in the battery system according to the present embodiment. In addition, the battery pack B-1 may be formed by combining a plurality of used single cells 10, and the thus configured battery pack B-1 may be used in the battery system according to the present embodiment.

Each of the battery packs B-2 to B-n also has a similar configuration to the battery pack B-1. That is, each of the battery packs B-2 to B-n has a plurality of serially connected single cells 10. Here, the number of the single cells 10 that constitute each of the plurality of battery packs B-1 to B-n may be equal to one another or may be different from one another. In addition, the battery packs B-2 to B-n may be respectively newly manufactured battery packs B-2 to B-n or may be respectively used battery packs B-2 to B-n.

The plurality of battery packs B-1 to B-n are connected in parallel with one another via a positive electrode line PL and a negative electrode line NL. The positive electrode line PL is branched by the number of the battery packs B-1 to B-n, and branch lines are respectively connected to the positive electrode terminals of the battery packs B-1 to B-n. The negative electrode line NL is branched by the number of the battery packs B-1 to B-n, and branch lines are respectively connected to the negative electrode terminals of the battery packs B-1 to B-n.

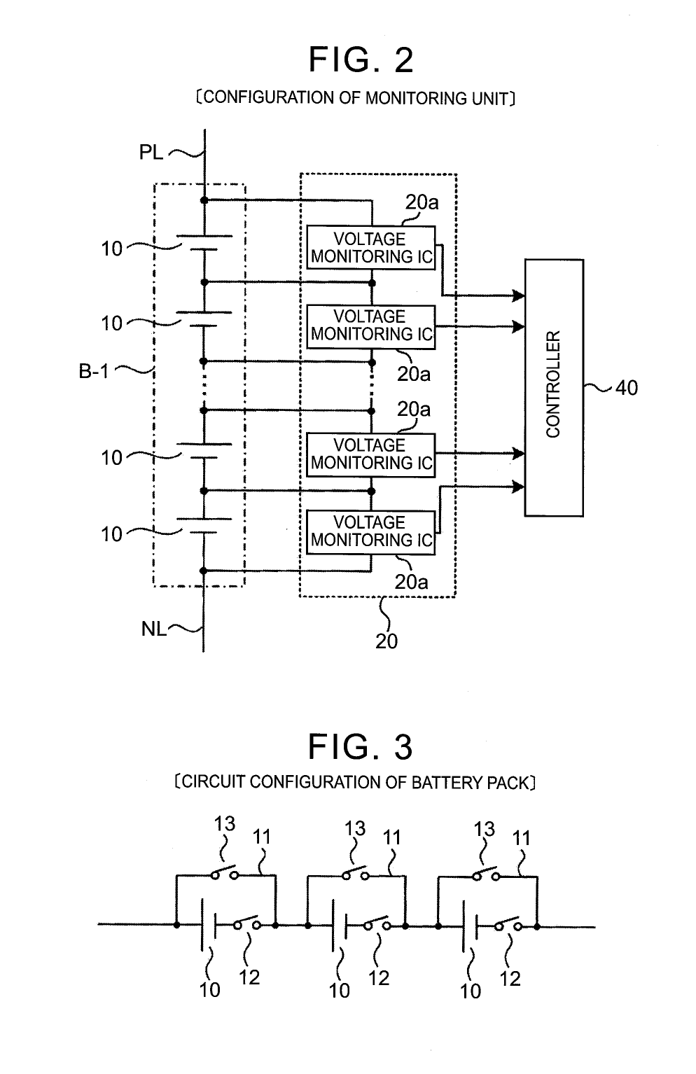

A monitoring unit 20 is provided in correspondence with each of the battery packs B-1 to B-n, detects a voltage value in a corresponding one of the battery packs B-1 to B-n, and outputs a detected result to a controller 40. Here, each monitoring unit 20 detects the voltage value of a corresponding one of the battery packs B-1 to B-n, and detects voltage values of the single cells 10 that constitute a corresponding one of the battery packs B-1 to B-n. As shown in FIG. 2, each monitoring unit 20 includes a plurality of voltage monitoring integrated circuits (ICs) 20a, and the number of the voltage monitoring ICs 20a is equal to the number of the single cells 10 included in each of the battery packs B-1 to B-n.

Each voltage monitoring IC 20a detects a voltage value of a corresponding one of the single cells 10, and outputs a detected result to the controller 40. When the voltage values of the single cells 10 respectively detected by the voltage monitoring ICs 20a are added together, it is possible to calculate the voltage value of each of the battery packs B-1 to B-n.

Here, when the plurality of single cells 10 that constitute each of the battery packs B-1 to B-n are divided into a plurality of battery blocks (which correspond to electrical storage elements), it is possible to detect the voltage value of each battery block. Each battery block is formed of a plurality of serially connected single cells 10. By connecting the plurality of battery blocks in series with one another, each of the battery packs B-1 to B-n is formed. When the voltage value of each battery block is detected, each voltage monitoring IC 20a is provided in correspondence with a corresponding one of the battery blocks.

A temperature sensor 21 is provided in correspondence with each of the battery packs B-1 to B-n, detects the temperature of a corresponding one of the battery packs B-1 to B-n, and outputs a detected result to the controller 40. Here, the single temperature sensor 21 may be provided in correspondence with each of the battery packs B-1 to B-n or a plurality of the temperature sensors 21 may be provided in correspondence with each of the battery packs B-1 to B-n. When the plurality of temperature sensors 21 are provided in correspondence with each of the battery packs B-1 to B-n, it is possible to detect the temperature of each single cell 10.

A current sensor 22 is provided in correspondence with each of the battery packs B-1 to B-n, and the number of the current sensors 22 is equal to the number of the battery packs B-1 to B-n. Each current sensor 22 detects a current value (charge current or discharge current) flowing through a corresponding one of the battery packs B-1 to B-n, and outputs a detected result to the controller 40. Here, the current value at the time of discharging each of the battery packs B-1 to B-n may be indicated by a positive value, and the current value at the time of charging each of the battery packs B-1 to B-n may be indicated by a negative value.

In the present embodiment, each current sensor 22 is provided in the negative electrode line NL; however, it is not limited to this configuration. That is, it is just required to be able to detect the current value flowing through each of the battery packs B-1 to B-n with the use of a corresponding one of the current sensors 22. For example, each current sensor 22 may be provided in the positive electrode line PL of a corresponding one of the battery packs B-1 to B-n.

On the other hand, relays R-1 to R-n are respectively provided in the negative electrode lines NL of the corresponding battery packs B-1 to B-n, and the number of the relays R-1 to R-n is equal to the number of the battery packs B-1 to B-n. Each of the relays R-1 to R-n switches between an on state and an off state upon reception of a control signal from the controller 40. For example, when the relay R-1 is in the on state, it is possible to charge or discharge the battery pack B-1. In addition, when the relay R-1 is in the off state, the battery pack B-1 is electrically isolated from a current path for charging or discharging, and the battery pack B-1 is not charged or discharged.

In the present embodiment, each of the relays R-1 to R-n is provided in the negative electrode line NL of a corresponding one of the battery packs B-1 to B-n; however, it is not limited to this configuration. Specifically, each of the relays R-1 to R-n may be provided in at least one of the positive electrode line PL and the negative electrode line NL of a corresponding one of the battery packs B-1 to B-n. When the relays R-1 to R-n are respectively provided in correspondence with the battery packs B-1 to B-n, it is possible to charge or discharge only a selected one of the battery packs among the plurality of battery packs B-1 to B-n by executing drive control over a corresponding one of the relays R-1 to R-n.

The plurality of battery packs B-1 to B-n are connected to a DC/DC converter 31 via the positive electrode line PL and the negative electrode line NL. The DC/DC converter 31 converts the output voltage of the battery packs B-1 to B-n to another voltage value. An inverter 32 converts direct-current power, which is output from the DC/DC converter 31, to alternating-current power. Alternating-current power output from the inverter 32 is supplied to a load 33. The load 33 just needs to be able to operate upon reception of the output power of the inverter 32. For example, a household electrical appliance may be used as the load 33.

In addition, the inverter 32 is connected to a power supply 34, and converts alternating-current power, which is output from the power supply 34, to direct-current power. For example, a commercial power supply may be used as the power supply 34. The DC/DC converter 31 converts the output voltage of the inverter 32 to another voltage value. The output power of the DC/DC converter 31 is allowed to be supplied to the battery packs B-1 to B-n and to charge the battery packs B-1 to B-n.

The controller 40 includes a memory 41. The memory 41 stores information that is used when the controller 40 executes predetermined processes (particularly, processes described in the present embodiment). In the present embodiment, the memory 41 is incorporated in the controller 40; instead, the memory 41 may be provided outside the controller 40.

Next, the circuit configuration of the battery pack B-1 according to the present embodiment will be described with reference to FIG. 3. FIG. 3 shows the circuit configuration hi part of the battery pack B-1. Here, each of the battery packs B-2 to B-n also has the configuration shown in FIG. 3.

A bypass circuit 11 is connected in correspondence with each of the single cells 10 that constitute the battery pack B-1. Each bypass circuit 11 is used when current at the time of charging or discharging the battery pack B-1 is not flowed to a corresponding one of the single cells 10. A switch 12 is provided between one end of each bypass circuit 11 and the negative electrode terminal of the single cell 10. In addition, a switch 13 is provided in each bypass circuit 11. The switches 12, 13 each switch between an on state and an off state upon reception of a control signal from the controller 40.

In the configuration shown in FIG. 3, the switch 12 is connected to the negative electrode terminal of the single cell 10; however, it is not limited to this configuration. Specifically, the switch 12 may be connected to the positive electrode terminal of the single cell 10.

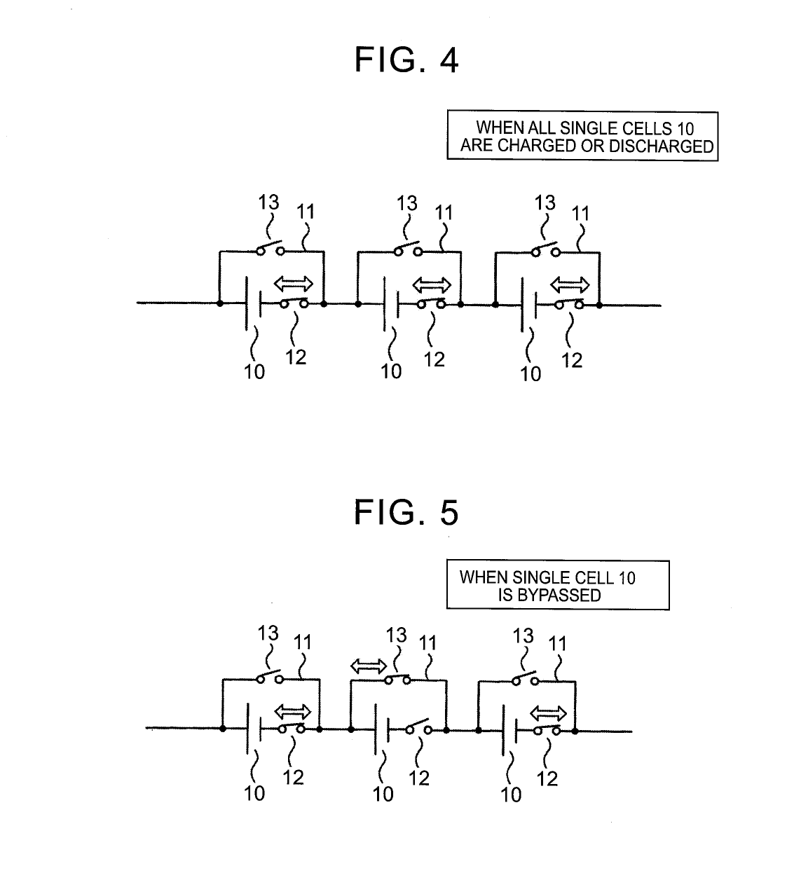

When current is flowed to all the single cells 10 that constitute the battery pack B-1, all the switches 12 are in the on state, and all the switches 13 are in the off state as shown in FIG. 4. Thus, it is possible to charge or discharge all the single cells 10. The arrows shown in FIG. 4 indicate a direction in which current flows at the time when the battery pack B-1 is charged or discharged.

On the other hand, when current is not flowed to only a specified one of the single cells 10, the corresponding switch 12 is turned off and the corresponding switch 13 is turned on for the specified one of the single cells 10 (the single cell 10 located in the middle in FIG. 5) as shown in FIG. 5. Here, for each of the single cells 10 located on the right and left in FIG. 5, the switch 12 is turned on and the switch 13 is turned off as in the case of FIG. 4.

Thus, current flows through the single cells 10 located on the right and left in FIG. 5, and no current flows through the single cell 10 located in the middle in FIG. 5. The arrows shown in FIG. 5 indicate a direction in which current flows at the time when the battery pack B-1 is charged or discharged. For the single cell 10 located in the middle in FIG. 5, current flows through the bypass circuit 11. In this way, not flowing current through the single cell 10 and flowing current through the bypass circuit 11 is termed bypassing.

In the configuration shown in FIG. 3, current is flowed through the single cell 10 or current is not flowed through the single cell 10 with the use of the corresponding bypass circuit 11 and switches 12, 13; however, it is not limited to this configuration. That is, it is possible to bypass a selected one of the single cells 10 with the use of a predetermined mechanism. For example, it is possible to bypass a selected one of the single cells 10 with the use of the mechanism described in Japanese Patent Application Publication No. 2012-69406 (JP 2012-69406 A).

In the present embodiment, as will be described later, even when there are variations in state of charge (SOC) among the plurality of battery packs B-1 to B-n, it is possible to discharge the battery packs B-1 to B-n until the state of charge (SOC) of all the battery packs B-1 to B-n becomes 0%, and it is possible to charge the battery packs B-1 to B-n until the SOC of all the battery packs B-1 to B-n becomes 100%. Here, the SOC is the percentage of a present amount of charge with respect to the full charge capacity.

In addition, in the present embodiment, as will be described later, even when there are variations in SOC among the plurality of single cells 10 that constitute each of the battery packs B-1 to B-n, it is possible to discharge all the single cells 10 until the SOC of all the single cells 10 becomes 0% and to charge all the single cells 10 until the SOC of all the single cells 10 becomes 100%. Here, when each single cell 10 is a nickel metal hydride battery, it is possible to cancel memory effect by changing the SOC of the single cell 10 from 0% to 100%.

By discharging all the battery packs B-1 to B-n or all the single cells 10 until the SOC of all the battery packs B-1 to B-n or all the single cells 10 becomes 0%, it is possible to fully utilize electric energy stored in all the battery packs B-1 to B-n or electric energy stored in all the single cells 10. That is, it is possible to consume electric energy stored in all the battery packs B-1 to B-n or all the single cells 10.

In addition, by charging all the battery packs B-1 to B-n or all the single cells 10 until the SOC of all the battery packs B-1 to B-n or all the single cells 10 becomes 100%, it is possible to store electric energy in all the battery packs B-1 to B-n or all the single cells 10. That is, it is possible to recover electric energy with the use of all the battery packs B-1 to B-n or all the single cells 10 without waste.

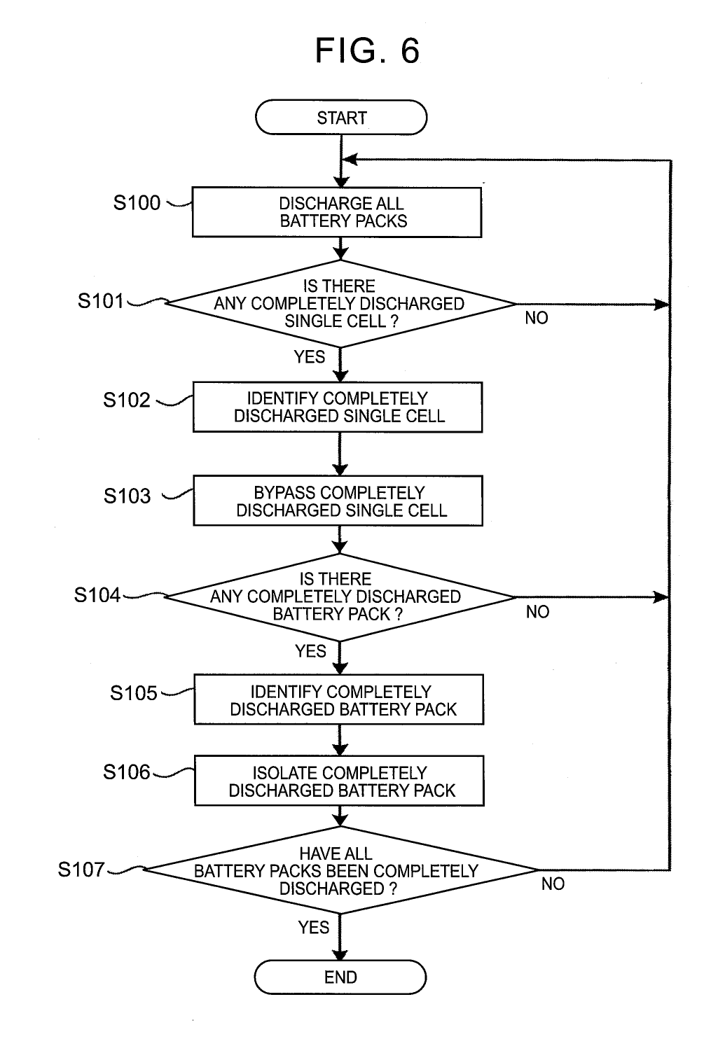

First, the process of discharging all the battery packs B-1 to B-n or all the single cells 10 until the SOC of all the battery packs B-1 to B-n or all the single cells 10 becomes 0% will be described with reference to the flowchart shown in FIG. 6. The flowchart shown in FIG. 6 is executed by the controller 40. In the present embodiment, a situation that the SOC reaches 0% includes not only a situation that the SOC completely reaches 0% but also a situation that the SOC substantially reaches 0%.

In step S100, the controller 40 discharges all the battery packs B-1 to B-n. Specifically, the controller 40 connects all the battery packs B-1 to B-n to the load 33 by switching each of the relays R-1 to R-n provided in correspondence with the battery packs B-1 to B-n from the off state to the on state. Thus, it is possible to discharge all the battery packs B-1 to B-n.

In step S101, the controller 40 determines whether any one of the battery packs B-1 to B-n includes the single cell 10 that has been completely discharged. Specifically, the controller 40 determines whether any one of the battery packs B-1 to B-n includes the single cell 10 of which the SOC has reached 0%.

Each of the battery packs B-1 to B-n is formed of the plurality of serially connected single cells 10, and there may be variations in SOC among the plurality of serially connected single cells 10. When there are variations in SOC, the SOC reaches 0% the earliest in the single cell 10 having the lowest SOC through a discharge of the battery packs B-1 to B-n. The process of determining whether the SOC of the single cell 10 has reached 0% will be described later.

When there is the single cell 10 of which the SOC has reached 0%, the process proceeds to step S102. When there is no single cell 10 of which SOC has reached 0%, the process returns to step S100.

In step S102, the controller 40 identifies the single cell 10 of which the SOC has reached 0%. By assigning identification information to all the single cells 10 that constitute each of the battery packs B-1 to B-n in advance, the controller 40 is able to identify the single cell 10 of which the SOC has reached 0% on the basis of the identification information.

Here, the identification information may be, for example, a number. In addition, the controller 40 is able to store the identification information of the single cell 10, of which the SOC has reached 0%, in the memory 41. Thus, the controller 40 is able to acquire the single cell 10 of which the SOC has reached 0% in each of the battery packs B-1 to B-n.

In step S103, the controller 40 bypasses the single cell 10 of which the SOC has reached 0%. Specifically, as described with reference to FIG. 3 to FIG. 5, the switch 12 is turned off and the switch 13 is turned on in the single cell 10 of which the SOC has reached 0%. Thus, it is possible to prevent a discharge of the single cell 10 of which the SOC has reached 0%, and to discharge only the single cells 10 of which the SOC has not reached 0%. Here, when the process shown in FIG. 6 is started, the switch 12 is in the on state and the switch 13 is in the off state in each of the single cells 10.

In step S104, the controller 40 determines whether there is a battery pack in which all the single cells 10 are bypassed. As each of the battery packs B-1 to B-n continues to be discharged, the SOC of each of the single cells 10 that constitute each of the battery packs B-1 to B-n decreases. As described above, the single cell 10 of which the SOC has reached 0% is bypassed. Therefore, as each of the battery packs B-1 to B-n continues to be discharged, the number of the bypassed single cells 10 increases.

Finally, all the single cells 10 that constitute each of the battery packs B-1 to B-n are bypassed. In the process of step S104, it is determined whether there is a battery pack in which all the single cells 10 are bypassed. As described above, the identification information of each single cell 10 of which the SOC has reached 0% is stored in the memory 41, so the controller 40 is able to determine whether all the single cells 10 are bypassed in each of the battery packs B-1 to B-n by referring to the identification information stored in the memory 41.

When there is a battery pack in which all the single cells 10 are bypassed, the process proceeds to step S105; otherwise, the process returns to step S100.

In step S105, the controller 40 identifies the battery pack in which all the single cells 10 are bypassed. By assigning identification information to the battery packs B-1 to B-n in advance, the controller 40 is able to identify the battery pack, in which all the single cells 10 are bypassed, on the basis of the identification information. Here, the identification information may be, for example, a number. In addition, the controller 40 is able to store the identification information of the battery pack, in which all the single cells 10 are bypassed, in the memory 41.

In step S106, the controller 40 isolates the battery pack, in which all the single cells 10 are bypassed, from the load 33. Specifically, the controller 40 switches the relay, corresponding to the battery pack to be isolated from the load 33, from the on state to the off state. Thus, it is possible to stop a discharge of the intended battery pack. Here, each battery pack that includes the not-bypassed single cells 10 continues to be discharged.

In step S107, the controller 40 determines whether all the battery packs B-1 to B-n are isolated from the load 33. Specifically, the controller 40 is able to determine whether all the battery packs B-1 to B-n are isolated from the load 33 by referring to the identification information of the battery packs B-1 to B-n, stored in the memory 41. When all the battery packs B-1 to B-n are isolated from the load 33, the process shown in FIG. 6 is ended. When at least one battery pack is connected to the load 33, the process returns to step S100.

With the process shown in FIG. 6, it is possible to discharge all the single cells 10 that constitute each of the battery packs B-1 to B-n until the SOC of each of the single cells 10 becomes 0%. In addition, it is possible to discharge all the battery packs B-1 to B-n until the SOC of each of the battery packs B-1 to B-n becomes 0%. Thus, when the process shown in FIG. 6 is ended, electric energy is not stored in any one of the single cells 10 that constitute all the battery packs B-1 to B-n.

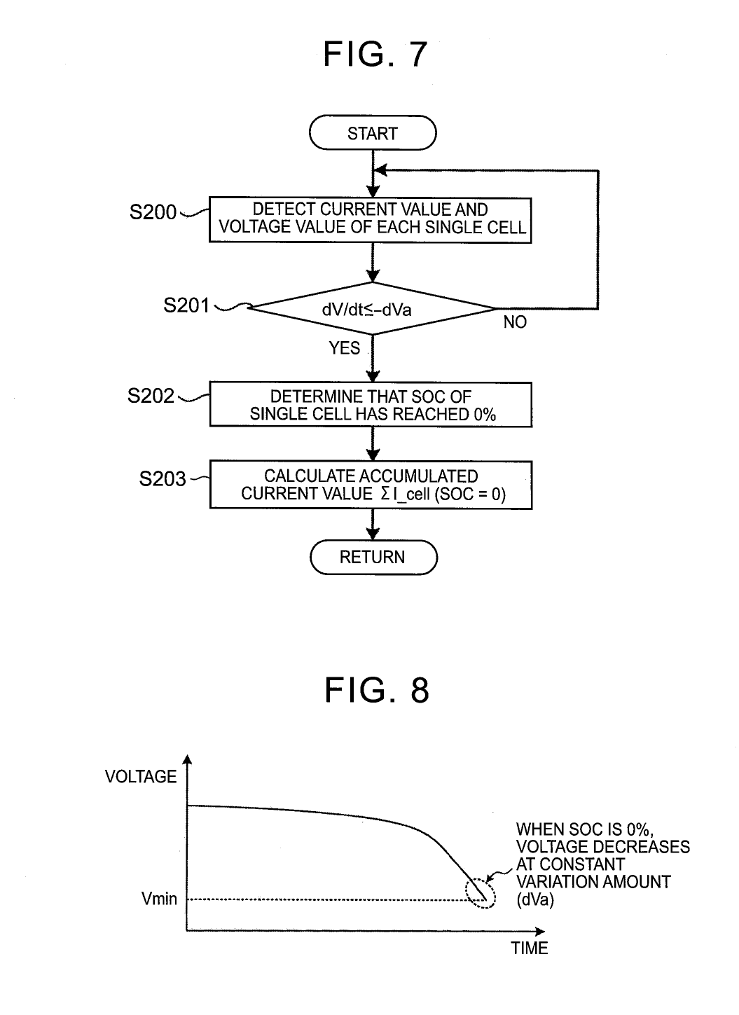

Next, the process of determining whether the SOC of the single cell 10 has reached 0% (the process of step S101 in FIG. 6) will be described with reference to the flowchart shown in FIG. 7. The process shown in FIG. 7 is executed by the controller 40.

In step S200, the controller 40 detects the current value and voltage value of each of the single cells 10 that constitute each of the battery packs B-1 to B-n while each of the battery packs B-1 to B-n is being discharged.

For example, the controller 40 is able to detect a current value (discharge current) flowing through the single cells 10 that constitute the battery pack B-1 on the basis of the output of the current sensor 22 provided in correspondence with the battery pack B-1. In addition, the controller 40 is able to detect the voltage value of each of the single cells 10 that constitute the battery pack B-1 on the basis of the output of the monitoring unit 20 provided in correspondence with the battery pack B-1. It is also possible to detect the current value and voltage value of each of the single cells 10 that constitute each of the battery packs B-2 to B-n by a similar method.

In step S201, the controller 40 calculates a voltage variation amount (dV/dt) per predetermined period of time. The voltage variation amount dV/dt is calculated for each of the single cells 10 that constitute each of the battery packs B-1 to B-n. When the battery packs B-1 to B-n are discharged, the voltage value of each of the single cells 10 that constitute each of the battery packs B-1 to B-n decreases with a lapse of time as shown in FIG. 8.

FIG. 8 shows a voltage behavior (one example) at the time when one single cell 10 is discharged. In FIG. 8, the ordinate axis represents the voltage value of the single cell 10, and the abscissa axis represents time. A voltage Vmin shown in FIG. 8 is a discharge termination voltage of the single cell 10.

As shown in a region surrounded by the dashed line in FIG. 8, when the SOC of the single cell 10 has reached 0%, the voltage value of the single cell 10 has a tendency to decrease at a constant variation amount dVa depending on the type of single cell 10. Therefore, by checking the voltage variation amount dVa, it is possible to determine whether the SOC of the single cell 10 has reached 0%. The voltage variation amount dVa may be obtained through an experiment, or the like, in advance, and information about the voltage variation amount dVa may be stored in the memory 41.

Specifically, in step S201, the controller 40 determines whether a condition expressed by the following mathematical expression (1) is satisfied. In the process shown in FIG. 7, each single cell 10 is being discharged, so the voltage variation amount dV/dt expressed by the following mathematical expression (1) is indicated by a negative value.

dV/dt≦−dVa (1)

When the condition expressed by the mathematical expression (1) is satisfied, the process proceeds to step S202. When the condition expressed by the mathematical expression (1) is not satisfied, the process returns to step S200. In step S202, the controller 40 determines that the SOC has reached 0% in the single cell 10 that satisfies the condition expressed by the mathematical expression (1). Thus, as described in the process of step S103 in FIG. 6, the controller 40 is able to bypass the single cell 10 of which the SOC has reached 0%.

In step S203, the controller 40 calculates an accumulated current value ΣI_cell (SOC=0) for the single cell 10 of which the SOC has reached 0%. In the process of step S200, the controller 40 detects the current value of each of the single cells 10 while the battery packs B-1 to B-n are being discharged. Therefore, by accumulating the current value detected during a period from when a discharge is started to when bypassing is performed, it is possible to calculate the accumulated current value ΣI_cell (SOC=0).

The accumulated current value ΣI_cell (SOC=0) is calculated for each of the single cells 10. Information about the accumulated current value ΣI_cell (SOC=0) may be stored in the memory 41 in association with the identification information of the corresponding single cell 10.

In the process shown in FIG. 7, it is determined that the SOC of the single cell 10 has reached 0% on the basis of the voltage variation amount dV/dt; however, it is not limited to this configuration. For example, by determining whether the voltage value of the single cell 10 has reached the voltage value (discharge termination voltage) Vmin shown in FIG. 8, it is possible to determine whether the SOC of the single cell 10 has reached 0%. When the SOC of the single cell 10 reaches 0%, the voltage value of the single cell 10 has reached the voltage value Vmin, so it is possible to determine that the SOC of the single cell 10 has reached 0% by recognizing a situation that the voltage value of the single cell 10 has reached the voltage value Vmin.

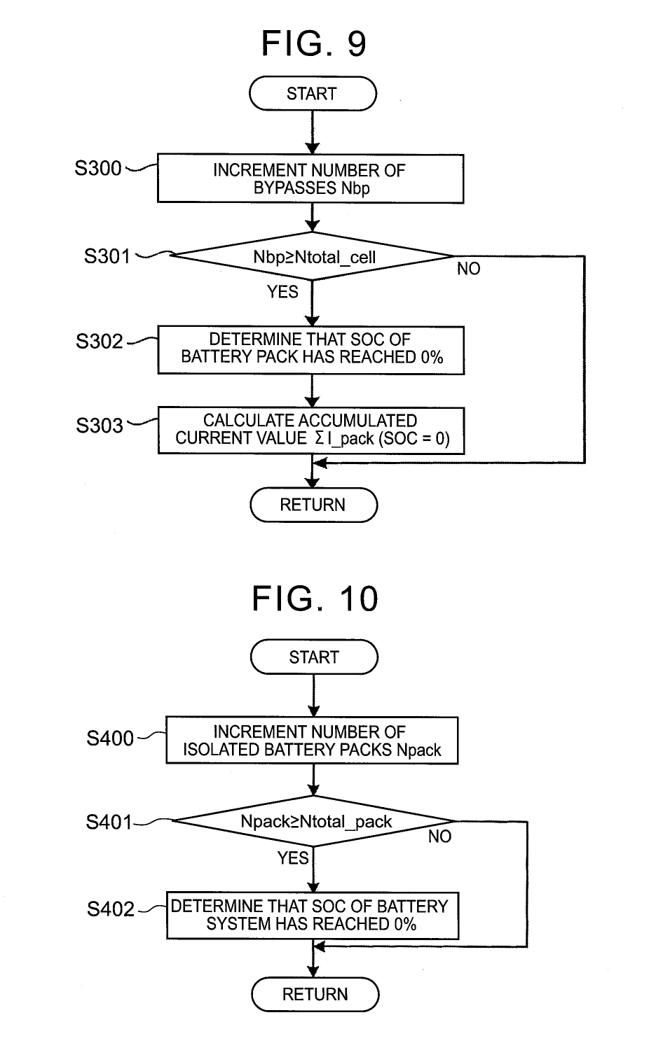

Next, the process of step S104 shown in FIG. 6 will be described with reference to the flowchart shown in FIG. 9. The process shown in FIG. 9 is executed by the controller 40.

As is described in the process of step S103 in FIG. 6, the controller 40 bypasses the single cell 10 of which the SOC has reached 0%. When bypassing has been performed, the controller 40 increments the number of bypasses Nbp in step S300. The number of bypasses Nbp indicates the number of times the single cell 10 has been bypassed, in other words, the number of the bypassed single cells 10. Information about the number of bypasses Nbp is stored in the memory 41. The number of bypasses Nbp is set for each of the battery packs B-1 to B-n.

In step S301, the controller 40 determines whether the number of bypasses Nbp is larger than or equal to a total number Ntotal_cell of the single cells 10 that constitute each of the battery packs B-1 to B-n. The total number Ntotal_cell may be obtained in advance, and information about the total number Ntotal_cell may be stored in the memory 41. When the number of bypasses Nbp is larger than or equal to the total number Ntotal_cell, the process proceeds to step S302. When the number of bypasses Nbp is smaller than the total number Ntotal_cell, the process shown in FIG. 9 is ended.

In step S302, the controller 40 determines that the SOC has reached 0% in the battery pack of which the number of bypasses Nbp is larger than or equal to the total number Ntotal_cell. When the number of bypasses Nbp has reached the total number Ntotal_cell, all the single cells 10 that constitute the battery pack are bypassed. In addition, the single cell 10 of which the SOC has reached 0% is bypassed, so the SOC has reached 0% in the battery pack of which the number of bypasses Nbp has reached the total number Ntotal_cell.

In step S303, the controller 40 calculates an accumulated current value ΣI_pack (SOC=0) for the battery pack of which the SOC has reached 0%. The controller 40 detects the current value of each of the battery packs B-1 to B-n on the basis of the output of the corresponding current sensor 22 while the battery packs B-1 to B-n are being discharged.

Therefore, by accumulating the current value detected during a period from when each of the battery packs B-1 to B-n starts to be discharged to when the SOC of each of the battery packs B-1 to B-n reaches 0%, it is possible to calculate the corresponding accumulated current value ΣI_pack (SOC=0). Here, the accumulated current value ΣI_pack (SOC=0) is equal to the accumulated current value ΣI_cell (SOC=0) of the single cell 10 of which the SOC has reached 0% at the end in each of the battery packs B-1 to B-n.

The accumulated current value ΣI_pack (SOC=0) is calculated for each of the battery packs B-1 to B-n. Information about the accumulated current value ΣI_pack (SOC=0) may be stored in the memory 41 in association with the identification information of the battery packs B-1 to B-n.

Next, the process of step S107 described in FIG. 6 will be described in detail with reference to the flowchart shown in FIG. 10. The process shown in FIG. 10 is executed by the controller 40.

As is described in the process of step S106 in FIG. 6, the controller 40 isolates the battery pack, of which the SOC has reached 0%, from the load 33. When the battery pack is isolated from the load 33, the controller 40 increments the number of isolated battery packs Npack in step S400. The number of isolated battery packs Npack indicates the number of battery packs not connected to the load 33, and falls within the range of 0 to n.

Here, each time any one of the battery pack is isolated from the load 33, the number of isolated battery packs Npack increases. Information about the number of isolated battery packs Npack is stored in the memory 41.

In step S401, the controller 40 determines whether the number of isolated battery packs Npack is larger than or equal to a total number Ntotal_pack of the battery packs B-1 to B-n. When the number of isolated battery packs Npack is larger than or equal to the total number Ntotal_pack, the process proceeds to step S402. When the number of isolated battery packs Npack is smaller than the total number Ntotal_pack, the process shown in FIG. 10 is ended.

In step S402, the controller 40 determines that the SOC of all the battery packs B-1 to B-n has reached 0% in the battery system shown in FIG. 1. When the SOC of all the battery packs B-1 to B-n has reached 0%, each of the battery packs B-1 to B-n is isolated from the load 33. Therefore, when the number of isolated battery packs Npack reaches the total number Ntotal_pack, the SOC of all the battery packs B-1 to B-n has reached 0%. Thus, the controller 40 is able to recognize that all the battery packs B-1 to B-n have been completely discharged.

After all the battery packs B-1 to B-n have been discharged, the process of charging all the battery packs B-1 to B-n is executed as will be described below.

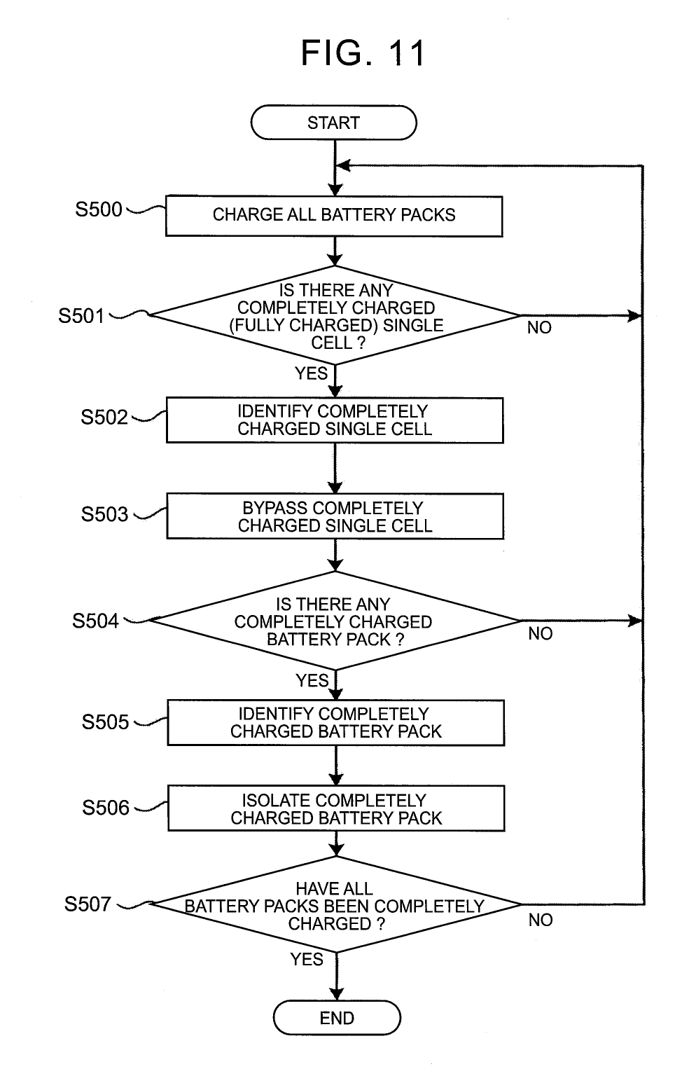

The process of charging all the battery packs B-1 to B-n or all the single cells 10 until the SOC of all the battery packs B-1 to B-n or all the single cells 10 reaches 100% will be described with reference to the flowchart shown in FIG. 11. The flowchart shown in FIG. 11 is executed by the controller 40.

In step S500, the controller 40 charges all the battery packs B-1 to B-n. Specifically, the controller 40 connects all the battery packs B-1 to B-n to the power supply 34 by switching each of the relays R-1 to R-n provided in correspondence with the battery packs B-1 to B-n from the off state to the on state. Thus, it is possible to supply electric power from the power supply 34 to all the battery packs B-1 to B-n, and it is possible to charge all the battery packs B-1 to B-n.

When. the battery packs B-1 to B-n are charged, it is possible to carry out, for example, constant current and constant voltage charge (CCCV charge). In the constant current and constant voltage charge, first, the battery packs B-1 to B-n are charged at a constant current, and, when the voltage of each of the battery packs B-1 to B-n (each single cell 10) has reached a predetermined voltage (charge termination voltage), the battery packs B-1 to B-n are charged at a constant voltage.

In step S501, the controller 40 determines whether the single cell 10 that has been completely charged is included in any one of the battery packs B-1 to B-n. Specifically, the controller 40 determines whether the single cell 10 of which the SOC has reached 100% is included in any one of the battery packs B-1 to B-n.

Each of the battery packs B-1 to B-n is formed of the plurality of serially connected single cells 10, and there may be variations in SOC among the plurality of serially connected single cells 10. When there are variations in SOC, the SOC reaches 100% the earliest in the single cell 10 having the highest SOC through a charge of the battery packs B-1 to B-n. The process of determining whether the SOC of the single cell 10 has reached 100% will be described later.

When there is the single cell 10 of which the SOC has reached 100%, the process proceeds to step S502. When there is no single cell 10 of which SOC has reached 100%, the process returns to step S500.

In step S502, the controller 40 identifies the single cell 10 of which the SOC has reached 100%. By assigning identification information to all the single cells 10 that constitute each of the battery packs B-1 to B-n in advance, the controller 40 is able to identify the single cell 10 of which the SOC has reached 100% on the basis of the identification information. Here, the controller 40 is able to store the identification information of the single cell 10, of which the SOC has reached 100%, in the memory 41.

In step S503, the controller 40 bypasses the single cell 10 of which the SOC has reached 100%. Specifically, as described with reference to FIG. 3 to FIG. 5, the switch 12 is turned off and the switch 13 is turned on in the single cell 10 of which the SOC has reached 100%.

Thus, it is possible to prevent the single cell 10 of which the SOC has reached 100% from being charged, and it is possible to charge only the single cells 10 of which the SOC has not reached 100%. Here, when the process shown in FIG. 11 is started, the switch 12 is in the on state and the switch 13 is in the off state in each of the single cells 10.

In step S504, the controller 40 determines whether there is a battery pack in which all the single cells 10 are bypassed. As each of the battery packs B-1 to B-n continues to be charged, the SOC of each of the single cells 10 that constitute each of the battery packs B-1 to B-n increases. As described above, the single cell 10 of which the SOC has reached 100% is bypassed. Therefore, as each of the battery packs B-1 to B-n continues to be charged, the number of the bypassed single cells 10 increases.

Finally, all the single cells 10 that constitute each of the battery packs B-1 to B-n are bypassed. In the process of step S504, it is determined whether there is a battery pack in which all the single cells 10 are bypassed. As described above, the identification information of each single cell 10 of which the SOC has reached 100% is stored in the memory 41, so the controller 40 is able to determine whether all the single cells 10 are bypassed in each of the battery packs B-1 to B-n by referring to the identification information stored in the memory 41.

When there is a battery pack in which all the single cells 10 are bypassed, the process proceeds to step S505; otherwise, the process returns to step S500.

In step S505, the controller 40 identifies the battery pack in which all the single cells 10 are bypassed. By assigning identification information to the battery packs B-1 to B-n in advance, the controller 40 is able to identify the battery pack, in which all the single cells 10 are bypassed, on the basis of the identification information. Here, the controller 40 is able to store the identification information of the battery pack, in which all the single cells 10 are bypassed, in the memory 41.

In step S506, the controller 40 isolates the battery pack, in which all the single cells 10 are bypassed, from the power supply 34. Specifically, the controller 40 switches the relay, corresponding to the battery pack to be isolated from the power supply 34, from the on state to the off state. Thus, it is possible to stop a charge of the intended battery pack. Here, each battery pack that includes the not-bypassed single cells 10 continues to be charged.

In step S507, the controller 40 determines whether all the battery packs B-1 to B-n are isolated from the power supply 34. That is, the controller 40 determines. whether all the battery packs B-1 to B-n have been completely charged.

Specifically, the controller 40 is able to determine whether all the battery packs B-1 to B-n are isolated from the power supply 34 by referring to the identification information of the battery packs B-1 to B-n, stored in the memory 41. When all the battery packs B-1 to B-n are isolated from the power supply 34, the process shown in FIG. 11 is ended. When at least one battery pack is connected to the power supply 34, the process returns to step S500.

With the process shown in FIG. 11, it is possible to charge all the single cells 10 that constitute each of the battery packs B-1 to B-n until the SOC of each of the single cells 10 becomes 100%. It is possible to charge all the battery packs B-1 to B-n until the SOC becomes 100%. Thus, when the process shown in FIG. 11 is ended, all the battery packs B-1 to B-n are in a full charge state, and all the single cells 10 that constitute each of the battery packs B-1 to B-n are in a full charge state.

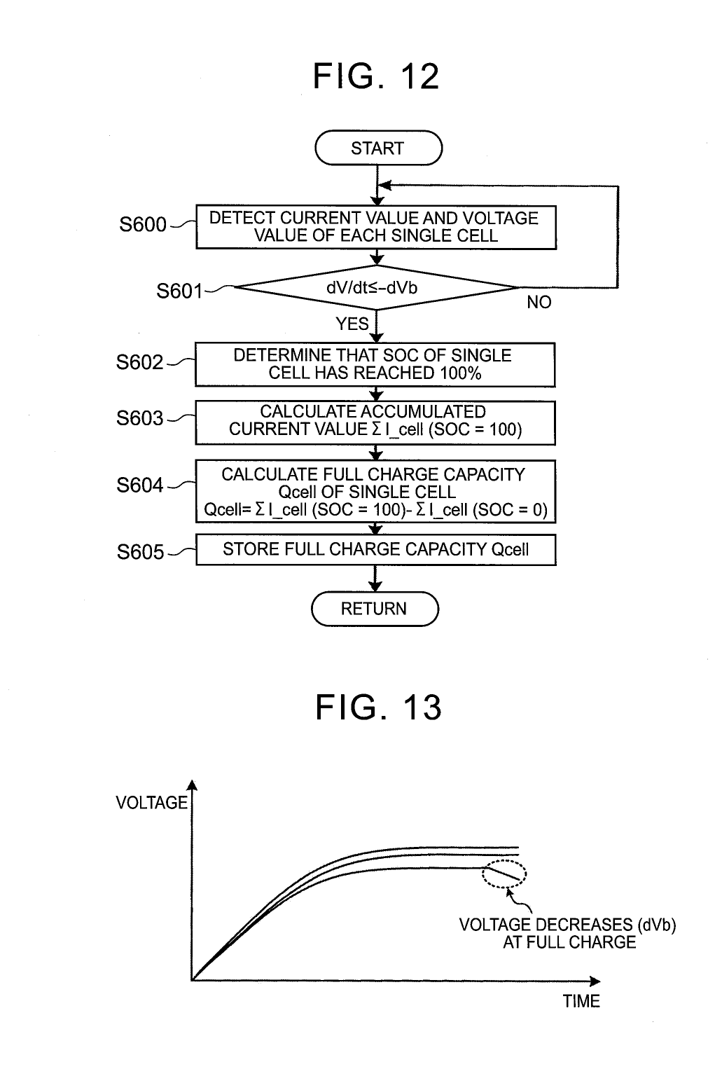

Next, the process of determining whether the SOC of the single cell 10 has reached 100% (the process of step S501 in FIG. 11) will be described with reference to the flowchart shown in FIG. 12. The process shown in FIG. 12 is executed by the controller 40.

In step S600, the controller 40 detects the current value and voltage value of each of the single cells 10 that constitute each of the battery packs B-1 to B-n while each of the battery packs B-1 to B-n is being charged.

For example, the controller 40 is able to detect a current value (charge current) flowing through the single cells 10 that constitute the battery pack B-1 on the basis of the output of the current sensor 22 provided in correspondence with the battery pack B-1. In addition, the controller 40 is able to detect the voltage value of each of the single cells 10 that constitute the battery pack B-1 on the basis of the output of the monitoring unit 20 provided in correspondence with the battery pack B-1. It is also possible to detect the current value and voltage value of each of the single cells 10 that constitute each of the battery packs B-2 to B-n by a similar method.

In step S601, the controller 40 calculates a voltage variation amount (dV/dt) per predetermined period of time. The voltage variation amount dV/dt is calculated for each of the single cells 10 that constitute each of the battery packs B-1 to B-n. When the battery packs B-1 to B-n are charged, the voltage value of each of the single cells 10 that constitute each of the battery packs B-1 to B-n increases with a lapse of time as shown in FIG. 13.

FIG. 13 shows a voltage behavior (one example) at the time when three single cell 10 are charged. In FIG. 13, the ordinate axis represents the voltage value of each single cell 10, and the abscissa axis represents time. As shown in FIG. 13, as the SOC approaches 100%, the voltage value of each single cell 10 is hard to vary.

As shown in a region surrounded by the dashed line in FIG. 13, after the SOC of the single cell 10 has reached 100%, the voltage value of the single cell 10 has a tendency to decrease depending on the type of single cell 10. Therefore, by checking the voltage variation amount dVb at this time, it is possible to determine whether the SOC of the single cell 10 has reached 100%. The voltage variation amount dVb may be obtained through an experiment, or the like, in advance, and information about the voltage variation amount dVb may be stored in the memory 41.

Specifically, in step S601, the controller 40 determines whether a condition expressed by the following mathematical expression (2) is satisfied.

dV/dt≦−dVb (2)

When the condition expressed by the mathematical expression (2) is satisfied, the process proceeds to step S602. When the condition expressed by the mathematical expression (2) is not satisfied, the process returns to step S600. In step S602, the controller 40 determines that the SOC has reached 100% in the single cell 10 that satisfies the condition expressed by the mathematical expression (2). Thus, as described in the process of step S503 in FIG. 11, the controller 40 is able to bypass the single cell 10 of which the SOC has reached 100%.

In step S603, the controller 40 calculates an accumulated current value ΣI_cell (SOC=100) for the single cell 10 of which the SOC has reached 100%. The controller 40 detects the current value of each of the single cells 10 on the basis of the output of the corresponding current sensor 22 while the battery packs B-1 to B-n are being charged. Therefore, by accumulating the current value detected during a period from when each of the battery packs B-1 to B-n (each of the single cells 10) starts to be charged to when the SOC of each of the single cells 10 reaches 100%, it is possible to calculate the corresponding accumulated current value ΣI_cell (SOC=100).

In step S604, the controller 40 calculates a full charge capacity Qcell of the single cell 10. Specifically, the controller 40 is able to calculate the full charge capacity Qcell by subtracting the accumulated current value ΣI_cell (SOC=0) calculated in the process of step S203 in FIG. 7 from the accumulated current value ΣI_cell (SOC=100) calculated in the process of step S603.

Here, values acquired for the same single cell 10 are used as the accumulated current values ΣI_cell (SOC=100), ΣI_cell (SOC=0). Here, the above-described identification information of each of the single cells 10 may be used to determine whether it is the same single cell 10.

After the process shown in FIG. 6 has been executed, the process shown in FIG. 11 and the process shown in FIG. 12 are executed. Therefore, when the accumulated current value ΣI_cell (SOC=100) has been calculated, the accumulated current value ΣI_cell (SOC=0) has been already obtained. Therefore, by using the two accumulated current values ΣI_cell (SOC=100), ΣI_cell (SOC=0), it is possible to calculate the full charge capacity Qcell of the single cell 10.

In the process shown in FIG. 11, the battery packs B-1 to B-n are charged until all the battery packs B-1 to B-n become a full charge state and all the single cells 10 that constitute each of the battery packs B-1 to B-n become a full charge state. Therefore, it is possible to calculate the full charge capacity Qcell for all the single cells 10.

In step S605, the controller 40 stores the full charge capacity Qcell of each single cell 10, calculated in the process of step S604, in the memory 41. For example, the controller 40 is able to store the full charge capacity Qcell of each single cell 10 in the memory 41 in association with the identification information of the single cell 10. Thus, the controller 40 is able to acquire the full charge capacity Qcell of each single cell 10.

If it is possible to acquire the full charge capacity Qcell of each single cell 10, it is possible to determine whether the SOC of each of the single cells 10 has reached 0% on the basis of the full charge capacity Qcell of each of the single cells 10 at the time of discharging the battery packs B-1 to B-n (single cells 10).

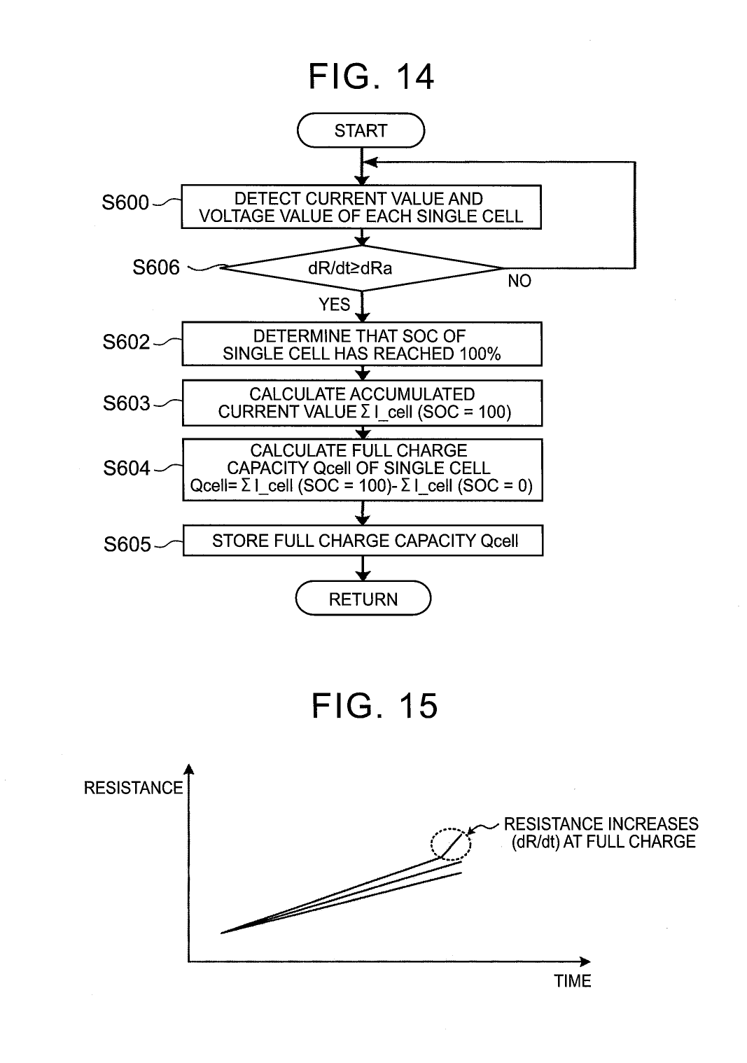

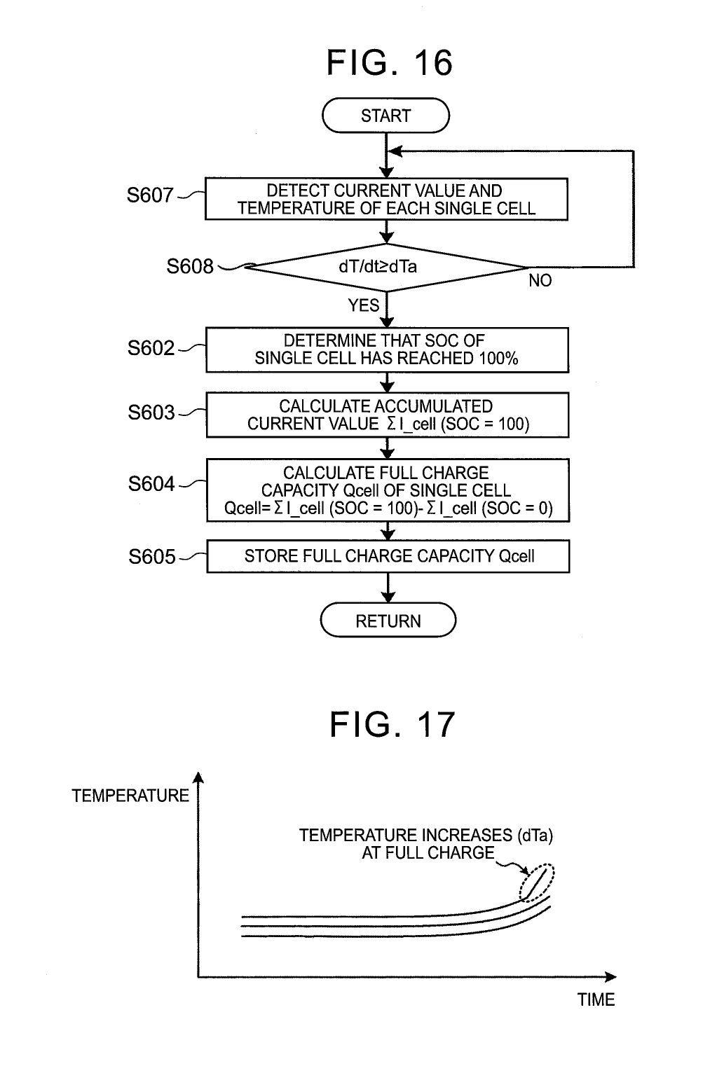

In the process shown in FIG. 12, it is determined whether the SOC of the single cell 10 has reached 100% on the basis of the voltage variation amount dV/dt; however, it is not limited to this configuration. For example, it is possible to determine whether the SOC of the single cell 10 has reached 100% through a first alternative embodiment and a second alternative embodiment to the present embodiment, which will be described below with reference to FIG. 14 and FIG. 16.

Initially, the process according to the first alternative embodiment will be described. The process according to the first alternative embodiment shown in FIG. 14 is executed by the controller 40. In FIG. 14, like reference numerals denote the same processes as the processes described with reference to FIG. 12, and the detailed description is omitted.

In the process shown in FIG. 14, the process of step S606 is executed instead of the process of step S601 shown in FIG. 12. In step S606, the controller 40 calculates a resistance variation amount (dR/dt) per predetermined period of time. The resistance variation amount dR/dt is calculated for each of the single cells 10 that constitute each of the battery packs B-1 to B-n.

It is possible to calculate the resistance value of each of the single cells 10 that constitute each of the battery packs B-1 to B-n from the current value and voltage value of each of the single cells 10. That is, by executing the process of step S600, it is possible to calculate the resistance value of each single cell 10. By monitoring the resistance value of each single cell 10 while the single cell 10 is being charged, it is possible to calculate the resistance variation amount dR/dt.

FIG. 15 shows variations (one example) in resistance value in three single cells 10. In FIG. 15, the ordinate axis represents the resistance value of each single cell 10, and the abscissa axis represents time.

As shown in a region surrounded by the dashed line in FIG. 15, after the SOC of the single cell 10 has reached 100%, the resistance value of the single cell 10 has a tendency to increase at a constant variation amount dRa depending on the type of single cell 10. Therefore, by checking the resistance variation amount dRa, it is possible to determine whether the SOC of the single cell 10 has reached 100%. The resistance variation amount dRa may be obtained through an experiment, or the like, in advance, and information about the resistance variation amount dRa may be stored in the memory 41.

Specifically, in step S606, the controller 40 determines whether a condition expressed by the following mathematical expression (3) is satisfied.

dR/dt≧dRa (3)

When the condition expressed by the mathematical expression (3) is satisfied, the process proceeds to step S602. When the condition expressed by the mathematical expression (3) is not satisfied, the process returns to step S600. In step S602, the controller 40 determines that the SOC has reached 100% in the single cell 10 that satisfies the condition expressed by the mathematical expression (3).

Next, the process according to the second alternative embodiment will be described. The process according to the second alternative embodiment shown in FIG. 16 is executed by the controller 40. In FIG. 16, like reference numerals denote the same processes as the processes described with reference to FIG. 12, and the detailed description is omitted.

In the process shown in FIG. 16, the processes of step S607 and step S608 are executed instead of the processes of step S600 and step S601 shown in FIG. 12. In step S607, the controller 40 detects the current value of each of the single cells 10 on the basis of the output of the corresponding current sensor 22, and detects the temperature of each of the single cells 10 on the basis of the output of the corresponding temperature sensor 21. Here, each of the temperature sensors 21 is able to detect the temperature of each of the single cells 10 included in each of the battery packs B-1 to B-n.

In step S608, the controller 40 calculates a temperature variation amount (dT/dt) in each single cell 10 per predetermined period of time. The temperature variation amount dT/dt is calculated for each of the single cells 10 that constitute each of the battery packs B-1 to B-n. The controller 40 is able to calculate the temperature variation amount dT/dt by monitoring the temperature of each single cell 10 while the single cell 10 is being charged.

FIG. 17 shows a variation in temperature in single cells 10. In FIG. 17, the ordinate axis represents the temperature of each single cell 10, and the abscissa axis represents time. FIG. 17 shows a variation (one example) in temperature in three single cells 10.

As shown in a region surrounded by the dashed line in FIG. 17, after the SOC of the single cell 10 has reached 100%, the temperature of the single cell 10 has a tendency to increase at a constant variation amount dTa depending on the type of single cell 10. Therefore, by checking the temperature variation amount dTa, it is possible to determine whether the SOC of the single cell 10 has reached 100%. The temperature variation amount dTa may be obtained through an experiment, or the like, in advance, and information about the temperature variation amount dTa may be stored in the memory 41.

Specifically, in step S608, the controller 40 determines whether a condition expressed by the following mathematical expression (4) is satisfied.

dT/dt≧dTa (4)

When the condition expressed by the mathematical expression (4) is satisfied, the process proceeds to step S602. When the condition expressed by the mathematical expression (4) is not satisfied, the process returns to step S607. In step S602, the controller 40 determines that the SOC has reached 100% in the single cell 10 that satisfies the condition expressed by the mathematical expression (4).

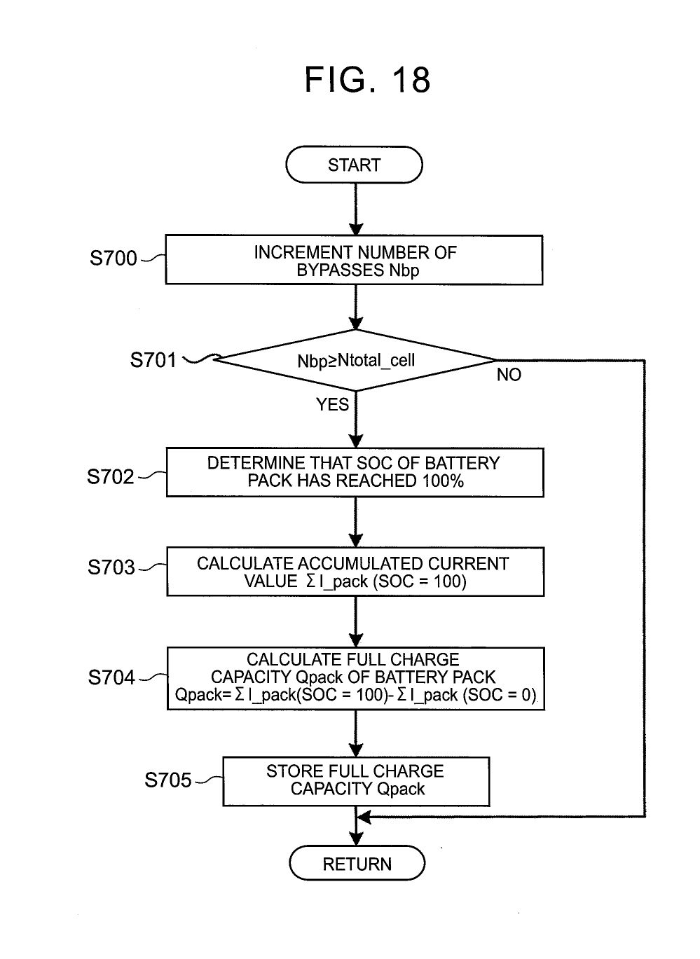

Next, the process of step S504 described in FIG. 11 will be described in detail with reference to the flowchart shown in FIG. 18. The process shown in FIG. 18 is executed by the controller 40.

As described in the process of step S503 in FIG. 11, the controller 40 bypasses the single cell 10 of which the SOC has reached 100%. When bypassing has been performed, the controller 40 increments the number of bypasses Nbp in step S700. Information about the number of bypasses Nhp is stored in the memory 41. The number of bypasses Nbp is set for each of the battery packs B-1 to B-n.

In step S701, the controller 40 determines whether the number of bypasses Nbp is larger than or equal to the total number Ntotal_cell of the single cells 10 that constitute each of the battery blocks B-1 to B-n. When the number of bypasses Nbp is larger than or equal to the total number Ntotal_cell, the process proceeds to step S702.

When the number of bypasses Nbp is smaller than the total number Ntotal_cell, the process shown in FIG. 18 is ended.

In step S702, the controller 40 determines that the SOC has reached 100% in the battery pack of which the number of bypasses Nbp is larger than or equal to the total number Ntotal_cell. When the number of bypasses Nbp has reached the total number Ntotal_cell, all the single cells 10 that constitute the battery pack are bypassed. In addition, the single cell 10 of which the SOC has reached 100% is bypassed, so the SOC has reached 100% in the battery pack of which the number of bypasses Nbp has reached the total number Ntotal_cell.

In step S703, the controller 40 calculates an accumulated current value ΣI_pack (SOC=100) for the battery pack of which the SOC has reached 100%. The controller 40 detects the current value of each of the battery packs B-1 to B-n on the basis of the output of the corresponding current sensor 22 while the battery packs B-1 to B-n are being charged.

Therefore, by accumulating the current value detected during a period from when each of the battery packs B-1 to B-n starts to be charged to when the SOC of each of the battery packs B-1 to B-n reaches 100%, it is possible to calculate the corresponding accumulated current value ΣI_pack (SOC=100). Here, the accumulated current value ΣI_pack (SOC=100) is equal to the accumulated current value ΣI_cell (SOC=100) of the single cell 10 of which the SOC has reached 100% at the end in each of the battery packs B-1 to B-n.

In step S704, the controller 40 calculates a full charge capacity Qpack of each of the battery packs B-1 to B-n. Specifically, the controller 40 is able to calculate the full charge capacity Qpack by subtracting the accumulated current value ΣI_pack (SOC=0) calculated in the process of step S303 in FIG. 9 from the accumulated current value ΣI_pack (SOC=100) calculated in the process of step S703. Here, values acquired for the same one of the battery packs B-1 to B-n are used as the accumulated current values ΣI_pack (SOC=100), ΣI_pack (SOC=0). Here, the above-described identification information of each of the battery packs B-1 to B-n may be used to determine whether it is the same one of the battery packs B-1 to B-n.

After the process shown in FIG. 6 has been executed, the process shown in FIG. 11 is executed. Therefore, when the accumulated current value ΣI_pack (SOC=100) has been calculated, the accumulated current value ΣI_pack (SOC=0) has been already obtained. Therefore, by using the two accumulated current values ΣI_pack (SOC=100), ΣI_pack (SOC=0), it is possible to calculate the full charge capacity Qpack of each of the battery packs B-1 to B-n.

In the process shown in FIG. 11, all the battery packs B-1 to B-n become a full charge state. Therefore, it is possible to calculate the full charge capacity Qpack for all the battery packs B-1 to B-n.

In step S705, the controller 40 stores the full charge capacity Qpack of each of the battery packs B-1 to B-n, calculated in the process of step S704, in the memory 41. For example, the controller 40 is able to store the full charge capacity Qpack of each of the battery packs B-1 to B-n in the memory 41 in association with the identification information of each of the battery packs B-1 to B-n. Thus, the controller 40 is able to acquire the full charge capacity Qpack of each of the battery packs B-1 to B-n.

If it is possible to acquire the full charge capacity Qpack of each of the battery packs B-1 to B-n, it is possible to determine whether the SOC of each of the battery packs B-1 to B-n has reached 0% on the basis of the full charge capacity Qpack of each of the battery packs B-1 to B-n at the time of discharging the battery packs B-1 to B-n.

While the invention has been described with reference to example embodiments thereof, it is to be understood that the invention is not limited to the described example embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. An electrical storage system comprising:
a plurality of electrical storage devices each including a plurality of electrical storage elements and bypass circuits each connected in parallel with a corresponding one of the electrical storage elements, the plurality of the electrical storage devices being connected in parallel with each other, and the plurality of the electrical storage elements being serially connected;
a plurality of relays each provided in correspondence with a corresponding one of the plurality of electrical storage devices, each of the plurality of the relays being configured to switch between a state where the corresponding one of the electrical storage devices is connected to a current path for charging or discharging and a state where the corresponding one of the electrical storage devices is isolated from the current path; and
a controller configured to control a charge or discharge of the plurality of electrical storage devices,
the controller being configured to isolate the completely discharged electrical storage element from the current path with the use of a corresponding one of the bypass circuits and isolate the completely discharged electrical storage device from the current path with the use of a corresponding one of the relays, when the plurality of electrical storage devices are discharged,
the controller being configured to isolate the completely charged electrical storage element from the current path with the use of a corresponding one of the bypass circuits and isolate the completely charged electrical storage device from the current path with the use of a corresponding one of the relays, when the plurality of electrical storage devices are charged, and
the controller being configured to calculate a full charge capacity of each of the electrical storage elements and a full charge capacity of each of the electrical storage devices by accumulating a current value flowing through each of the electrical storage elements and each of the electrical storage devices until the corresponding electrical storage element or the corresponding electrical storage device is isolated from the current path, when the plurality of electrical storage devices are charged after being discharged.

2. The electrical storage system according to claim 1, wherein
the controller is configured to isolate the any one of the electrical storage elements, of which an SOC has reached 0%, from the current path with the use of a corresponding one of the bypass circuits, when the controller has determined that the SOC of any one of the electrical storage elements has reached 0%.

3. The electrical storage system according to claim 2, further comprising:
first switches respectively connected in series with the electrical storage elements; and
second switches respectively arranged in the bypass circuits, wherein
the controller is configured to isolate the electrical storage element by turning off a corresponding one of the first switches and turning on a corresponding one of the second switches.

4. The electrical storage system according to claim 2, wherein
the controller is configured to determine that the SOC of the electrical storage element has reached 0% on the basis of a voltage variation amount of the electrical storage element per predetermined period of time.

5. The electrical storage system according to claim 2, wherein
the controller is configured to determine that the SOC of the electrical storage element has reached 0% on the basis of a discharge termination voltage of the electrical storage element per predetermined period of time.

6. The electrical storage system according to claim 1, wherein
the controller is configured to determine that the electrical storage device has been completely discharged on the basis of the fact that all the electrical storage elements included in the electrical storage device are isolated from the current path, when the plurality of electrical storage devices are discharged.

7. The electrical storage system according to claim 1, wherein the controller is configured to isolate the any one of the electrical storage elements, of which an SOC has reached 100%, from the current path with the use of a corresponding one of the bypass circuits, when the controller has determined that the SOC of any one of the electrical storage elements has reached 100%.

8. The electrical storage system according to claim 7, wherein
the controller is configured to determine that the SOC of the electrical storage element has reached 100% on the basis of a voltage variation amount of the electrical storage element per predetermined period of time.

9. The electrical storage system according to claim 7, wherein
the controller is configured to determine that the SOC of the electrical storage element has reached 100% on the basis of a resistance variation amount of the electrical storage element per predetermined period of time.

10. The electrical storage system according to claim 7, wherein
the controller is configured to determine that the SOC of the electrical storage element has reached 100% on the basis of a temperature variation amount of the electrical storage element per predetermined period of time.

11. The electrical storage system according to claim 1, wherein
the controller is configured to determine that the electrical storage device has been completely charged on the basis of the fact that all the electrical storage elements included in the electrical storage device are isolated from the current path, when the plurality of electrical storage devices are charged.

12. A control method of controlling a charge or discharge of a plurality of electrical storage devices, each including a plurality of electrical storage elements and bypass circuits each connected, in parallel with a corresponding one of the electrical storage elements, the plurality of the electrical storage devices being connected in parallel with each other, and the plurality of the electrical storage elements being serially connected, the control method comprising:
isolating the completely discharged electrical storage element from the current path with the use of a corresponding one of the bypass circuits and isolating the completely discharged electrical storage device from the current path with the use of a corresponding one of the relays each provided in correspondence with a corresponding one of the electrical storage devices, when the plurality of electrical storage devices are discharged,
isolating the completely charged electrical storage element from the current path with the use of a corresponding one of the bypass circuits and isolating the completely charged electrical storage device from the current path with the use of a corresponding one of the relays, when the plurality of electrical storage devices are charged, and
calculating a full charge capacity of each of the electrical storage elements and a full charge capacity of each of the electrical storage devices by accumulating a current value flowing through each of the electrical storage elements and each of the electrical storage devices until the corresponding electrical storage element or the corresponding electrical storage device is isolated from the current path, when the plurality of electrical storage devices are charged after being discharged.
